(19) United States
(12) Patent Application Publication
(10) Pub. No.: US 2026/0270014 A1
(43) Pub. Date: Sep. 10, 2026

(54) CHANNEL AWARE CONTROL RESOURCE SET ALLOCATION

(71) Applicant: QUALCOMM Incorporated, San Diego, CA (US)

(72) Inventors: Aviv REGEV, Tel Aviv (IL); Ronen SHAKED, Kfar Saba (IL); Shay LANDIS, Hod Hasharon (IL); Amit MOSES, Tel Aviv (IL)

(21) Appl. No.: 19/069,796

(22) Filed: Mar. 4, 2025

(51) Int. Cl. H04L 5/00; H04W 72/23

(52) U.S. Cl. CPC H04L 5/0053; H04W 72/23

(57) ABSTRACT

Various aspects of the present disclosure generally relate to wireless communication. In some aspects, a user equipment (UE) may receive configuration information indicating a set of control resource sets (CORESETs), wherein the configuration information indicates sets of allocation properties associated with respective CORESETs included in the set of CORESETs. The UE may receive a physical downlink control channel (PDCCH) communication based at least in part on monitoring resources associated with a CORESET included in the set of CORESETs. Numerous other aspects are described.

### FIELD OF THE DISCLOSURE

Aspects of the present disclosure generally relate to wireless communication and specifically relate to techniques, apparatuses, and methods associated with channel aware control resource set allocation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A control resource set (CORESET) is a set of physical resources used to carry control information. In NR, the CORESETs allocation of physical resources may be flexible across a frequency domain and a time domain. For example, a CORESET can be configured with varying sizes and locations in the frequency and time domains.

### SUMMARY

Some aspects described herein relate to a method of wireless communication performed by a user equipment (UE). The method may include receiving configuration information indicating a set of control resource sets (CORESETs), wherein the configuration information indicates sets of allocation properties associated with respective CORESETs included in the set of CORESETs. The method may include receiving a physical downlink control channel (PDCCH) communication based at least in part on monitoring resources associated with a CORESET included in the set of CORESETs.

Some aspects described herein relate to a method of wireless communication performed by a network node. The method may include transmitting configuration information indicating a set of CORESETs, wherein the configuration information indicates sets of allocation properties associated with respective CORESETs included in the set of CORESETs. The method may include transmitting a PDCCH communication via resources associated with a CORESET included in the set of CORESETs.

Some aspects described herein relate to a UE for wireless communication. The UE may include a processing system. The processing system may include one or more processors and one or more code-storing memories coupled with the one or more processors. The processing system may be configured to cause the one or more processors, coupled to receive configuration information indicating a set of CORESETs, wherein the configuration information indicates sets of allocation properties associated with respective CORESETs included in the set of CORESETs. The processing system may be configured to cause the one or more processors, coupled to receive a PDCCH communication based at least in part on monitoring resources associated with a CORESET included in the set of CORESETs.

Some aspects described herein relate to a network node for wireless communication. The network node may include a processing system. The processing system may include one or more processors and one or more code-storing memories coupled with the one or more processors. The processing system may be configured to cause the one or more processors, coupled to transmit configuration information indicating a set of CORESETs, wherein the configuration information indicates sets of allocation properties associated with respective CORESETs included in the set of CORESETs. The processing system may be configured to cause the one or more processors, coupled to transmit a PDCCH communication via resources associated with a CORESET included in the set of CORESETs.

Some aspects described herein relate to a non-transitory computer-readable medium that stores a set of instructions for wireless communication by a UE. The set of instructions, when executed by one or more processors of the UE, may cause the UE to receive configuration information indicating a set of CORESETs, wherein the configuration information indicates sets of allocation properties associated with respective CORESETs included in the set of CORESETs. The set of instructions, when executed by one or more processors of the UE, may cause the UE to receive a PDCCH communication based at least in part on monitoring resources associated with a CORESET included in the set of CORESETs.

Some aspects described herein relate to a non-transitory computer-readable medium that stores a set of instructions for wireless communication by a network node. The set of instructions, when executed by one or more processors of the network node, may cause the network node to transmit configuration information indicating a set of CORESETs, wherein the configuration information indicates sets of allocation properties associated with respective CORESETs included in the set of CORESETs. The set of instructions, when executed by one or more processors of the network node, may cause the network node to transmit a PDCCH communication via resources associated with a CORESET included in the set of CORESETs.

Some aspects described herein relate to an apparatus for wireless communication. The apparatus may include means for receiving configuration information indicating a set of CORESETs, wherein the configuration information indicates sets of allocation properties associated with respective CORESETs included in the set of CORESETs. The apparatus may include means for receiving a PDCCH communication based at least in part on monitoring resources associated with a CORESET included in the set of CORESETs.

Some aspects described herein relate to an apparatus for wireless communication. The apparatus may include means for transmitting configuration information indicating a set of CORESETs, wherein the configuration information indicates sets of allocation properties associated with respective CORESETs included in the set of CORESETs. The apparatus may include means for transmitting a PDCCH communication via resources associated with a CORESET included in the set of CORESETs.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example resource structure for wireless communication.

FIG. 4 is a diagram illustrating an example associated with channel aware control resource set allocation.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

In an Long Term Evolution (LTE) network, control information may be transmitted via a physical downlink control channel (PDCCH). The PDCCH may be configured in dedicated orthogonal frequency division multiplexing (OFDM) symbols. Further, data is not allowed to be transmitted via the dedicated OFDM symbols.

To increase spectrum efficiency and channel capacity, 5G New Radio (NR) utilizes a control resource set (CORESET) for transmission of control information. A CORESET may comprise a set of physical resources used to carry control information (e.g., a set of resources corresponding to a PDCCH).

In contrast to the dedicated OFDM symbols in LTE, the physical resources of a CORESET may be allocated with varying sizes and location in the time and frequency domains, which may allow for a more flexible and efficient use of resources. In some cases, the flexibility in the allocation of the physical resources of a CORESET may enable increased mitigation of inter-cell interference, which may enable a network to achieve a higher performance level (e.g., relative to an LTE network) in a dense network environment. In some cases, the flexibility in the allocation of the physical resources of a CORESET may enable advanced features such as beamforming and massive multiple-input multiple-output (MIMO) communications that can be used to achieve higher data rates and lower latency relative to an LTE network. In some cases, the flexibility in the allocation of the physical resources of a CORESET may enable the efficient sharing of resources between control and data channels, which may reduce signaling overhead and may improve overall network efficiency.

Various aspects relate generally to publishing, at the beginning of a communication session, sets of nominated CORESETs with each of the nominated CORESETs being associated with its own properties. Some aspects more specifically relate to a network node providing configuration information indicating a set of CORESETs. In some aspects, the configuration information indicates sets of allocation properties associated with respective CORESETs included in the set of CORESETs. In some aspects, a CORESET may be selected from the set of CORESETs based at least in part on a downlink channel condition that is known at the network node and a user equipment (UE) with which the network node is communicating. In some aspects, the downlink channel condition may be associated with a reference signal received power (RSRP), a channel capacity, a signal-to-noise ratio (SNR), or mutual information associated with CORESETs included in the set of CORESETs.

Particular aspects of the subject matter described in this disclosure can be implemented to realize one or more of the following potential advantages. In some examples, the described techniques can be used to modify a configuration of a CORESET at a physical layer rather than a radio link control (RLC) layer thereby reducing a latency associated with modifying a configuration of a CORESET. Additionally, the described techniques can be used to modify a configuration of a CORESET without transmitting an updated PDCCH configuration information element, thereby reducing an amount of data required to be communicated to modify a configuration of a CORESET.

5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

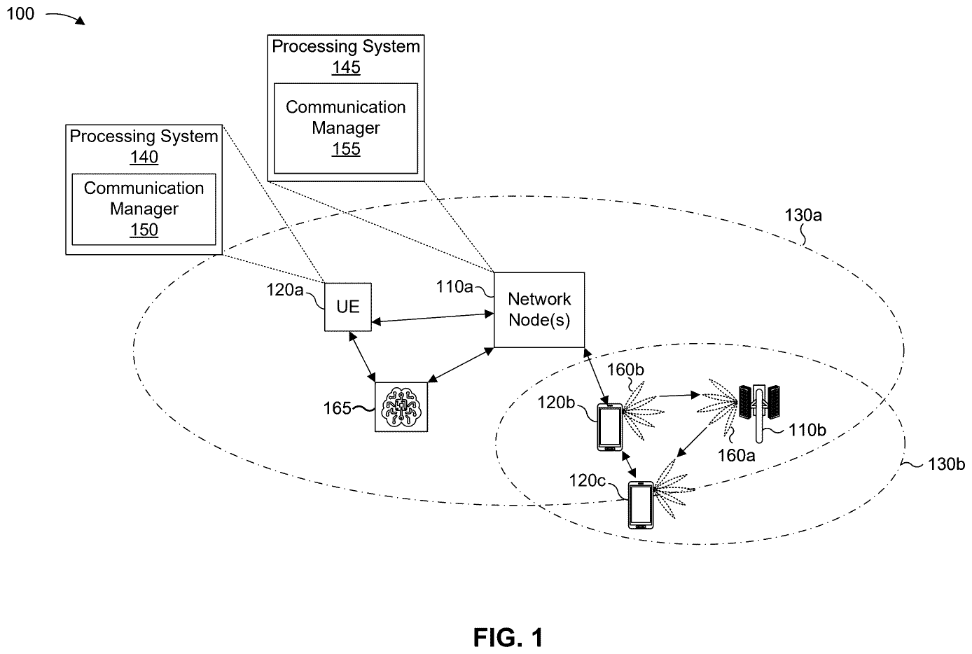

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of an RLC layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-OFDM (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE 120 may include a communication manager 150. As described in more detail elsewhere herein, the communication manager 150 may receive configuration information indicating a set of CORESETs, wherein the configuration information indicates sets of allocation properties associated with respective CORESETs included in the set of CORESETs; and receive a PDCCH communication based at least in part on monitoring resources associated with a CORESET included in the set of CORESETs. Additionally, or alternatively, the communication manager 150 may perform one or more other operations described herein.

In some aspects, a network node 110 may include a communication manager 155. As described in more detail elsewhere herein, the communication manager 155 may transmit configuration information indicating a set of CORESETs, wherein the configuration information indicates sets of allocation properties associated with respective CORESETs included in the set of CORESETs; and transmit a PDCCH communication via resources associated with a CORESET included in the set of CORESETs. Additionally, or alternatively, the communication manager 155 may perform one or more other operations described herein.

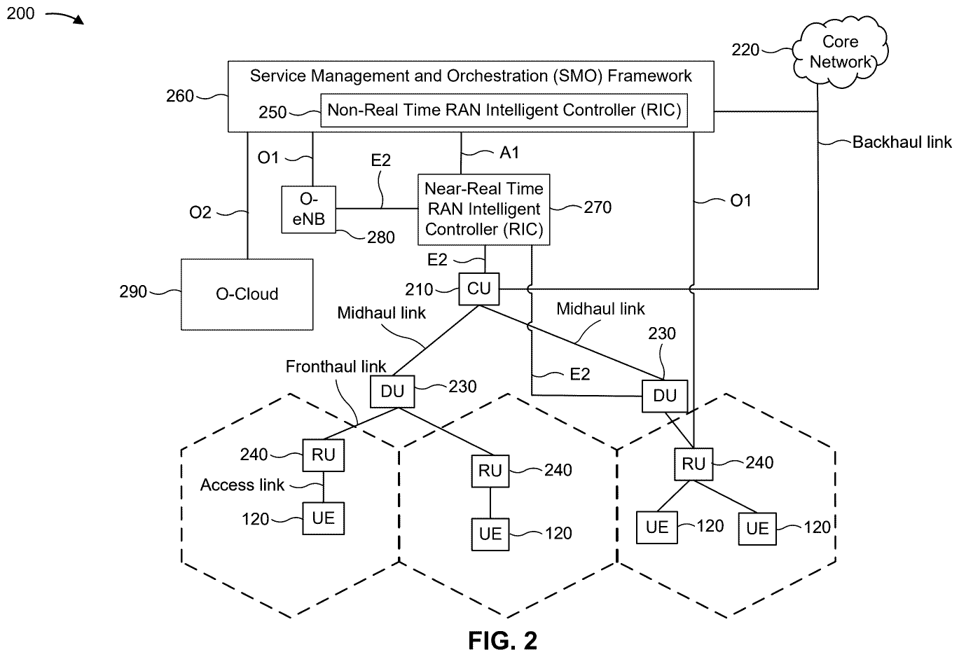

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

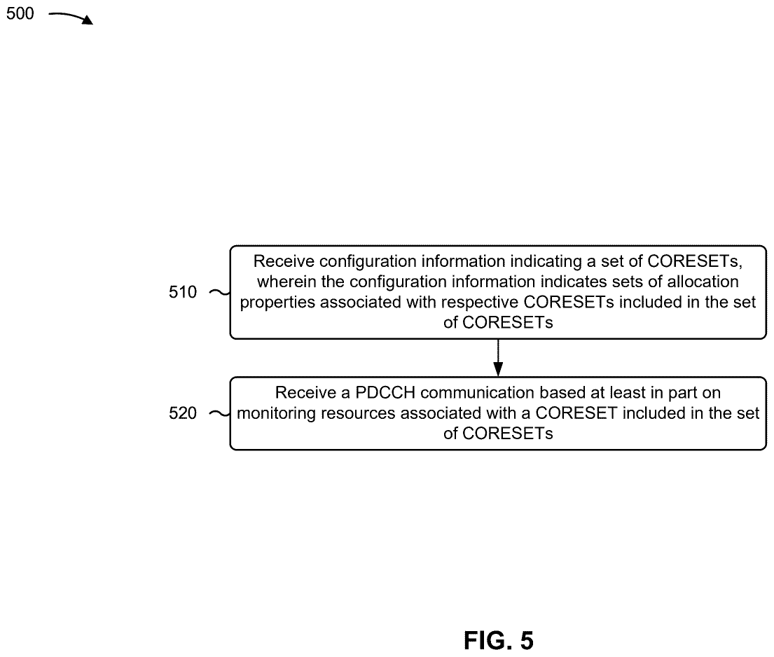

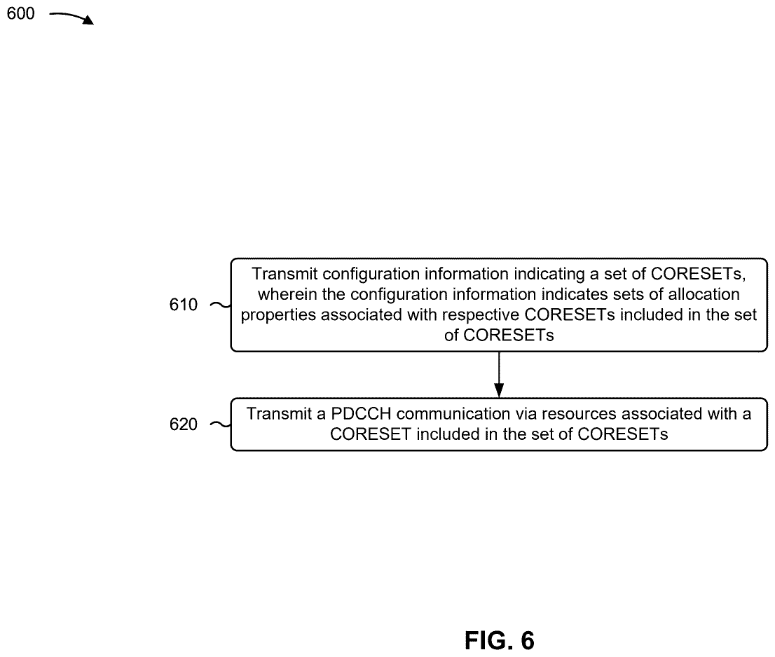

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with channel aware CORESET allocation, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

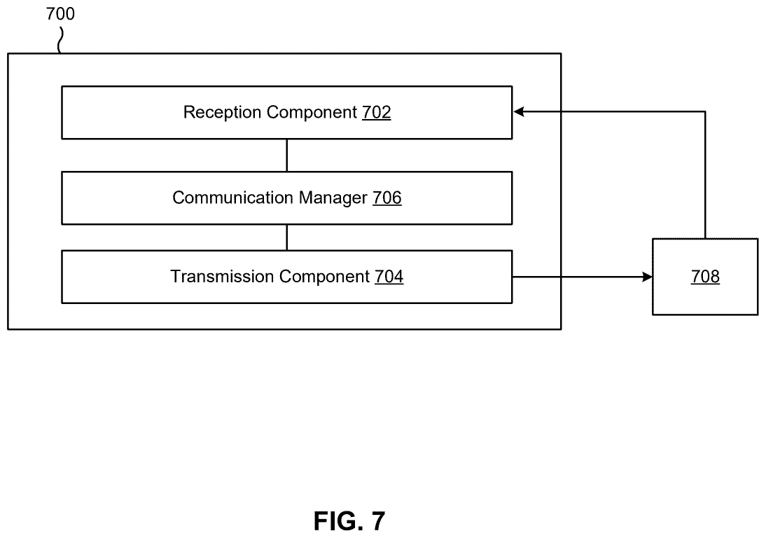

In some aspects, a UE includes means for receiving configuration information indicating a set of CORESETs, wherein the configuration information indicates sets of allocation properties associated with respective CORESETs included in the set of CORESETs; or means for receiving a PDCCH communication based at least in part on monitoring resources associated with a CORESET included in the set of CORESETs. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

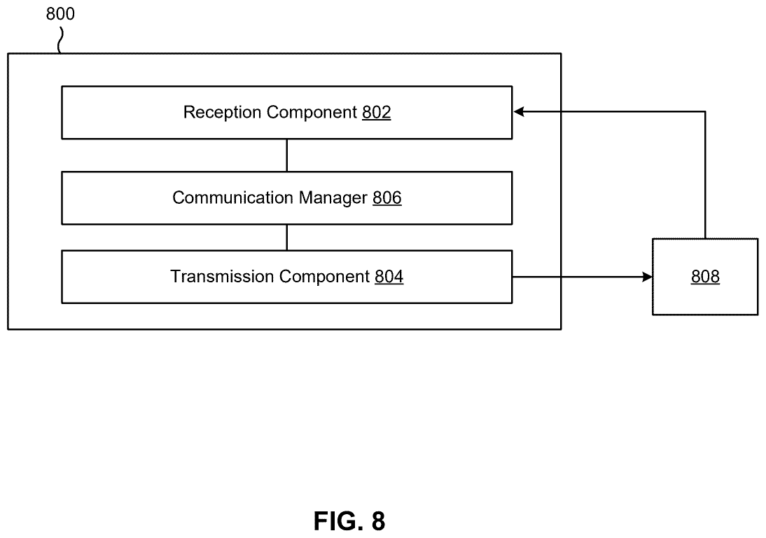

In some aspects, a network node includes means for transmitting configuration information indicating a set of CORESETs, wherein the configuration information indicates sets of allocation properties associated with respective CORESETs included in the set of CORESETs; or means for transmitting a PDCCH communication via resources associated with a CORESET included in the set of CORESETs. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

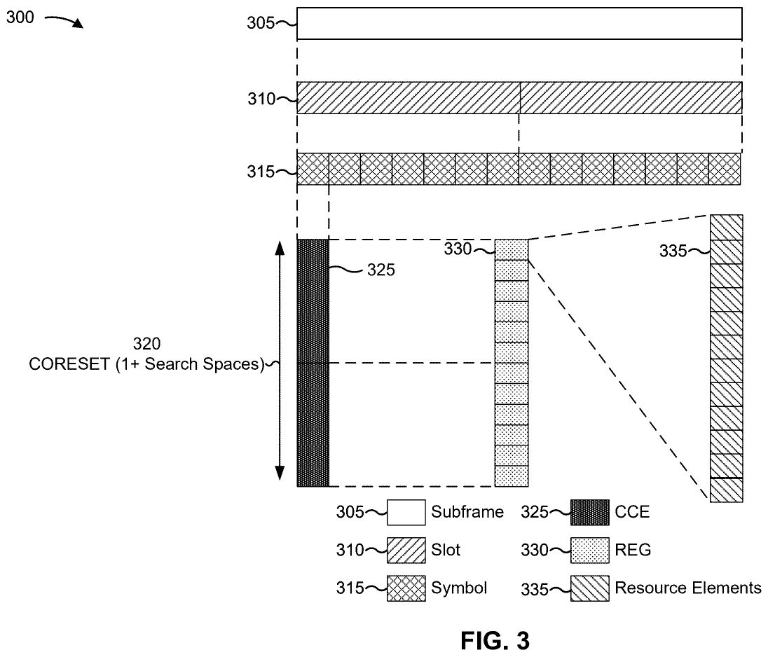

FIG. 3 is a diagram illustrating an example resource structure 300 for wireless communication. Resource structure 300 shows an example of various groups of resources described herein. As shown, resource structure 300 may include a subframe 305. Subframe 305 may include multiple slots 310. While resource structure 300 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes or slots. A slot 310 may include multiple symbols 315, such as 14 symbols per slot.

The potential control region of a slot 310 may be referred to as a CORESET 320 and may be structured to support an efficient use of resources, such as by flexible configuration or reconfiguration of resources of the CORESET 320 for one or more PDCCHs or one or more PDSCHs. In some aspects, the CORESET 320 may occupy the first symbol 315 of a slot 310, the first two symbols 315 of a slot 310, or the first three symbols 315 of a slot 310. Thus, a CORESET 320 may include multiple RBs in the frequency domain, and either one, two, or three symbols 315 in the time domain. In 5G, a quantity of resources included in the CORESET 320 may be flexibly configured, such as by using RRC signaling to indicate a frequency domain region (e.g., a quantity of resource blocks) or a time domain region (e.g., a quantity of symbols) for the CORESET 320.

As illustrated, a symbol 315 that includes CORESET 320 may include one or more control channel elements (CCEs) 325, shown as two CCEs 325 as an example, that span a portion of the system bandwidth. A CCE 325 may include DCI that is used to provide control information for wireless communication. A network node may transmit DCI during multiple CCEs 325 (as shown), where the quantity of CCEs 325 used for transmission of DCI represents the aggregation level (AL) used by the network node for the transmission of DCI. In FIG. 3, an aggregation level of two is shown as an example, corresponding to two CCEs 325 in a slot 310. In some aspects, different aggregation levels may be used, such as 1, 2, 4, 8, 16, or another aggregation level.

Each CCE 325 may include a fixed quantity of resource element groups (REGs) 330, shown as 6 REGs 330, or may include a variable quantity of REGs 330. In some aspects, the quantity of REGs 330 included in a CCE 325 may be specified by a REG bundle size. A REG 330 may include one resource block, which may include 12 resource elements (REs) 335 within a symbol 315. A resource element 335 may occupy one subcarrier in the frequency domain and one OFDM symbol in the time domain.

A search space may include all possible locations (e.g., in time or frequency) where a PDCCH may be located. A CORESET 320 may include one or more search spaces, such as a UE-specific search space, a group-common search space, or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) or an aggregation level being used. A possible location (e.g., in time or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 320 may be interleaved or non-interleaved. An interleaved CORESET 320 may have CCE-to-REG mapping such that adjacent CCEs are mapped to scattered REG bundles in the frequency domain (e.g., adjacent CCEs are not mapped to consecutive REG bundles of the CORESET 320). A non-interleaved CORESET 320 may have a CCE-to-REG mapping such that all CCEs are mapped to consecutive REG bundles (e.g., in the frequency domain) of the CORESET 320.

As indicated above, FIG. 3 is provided as an example. Other examples may differ from what is described with respect to FIG. 3.

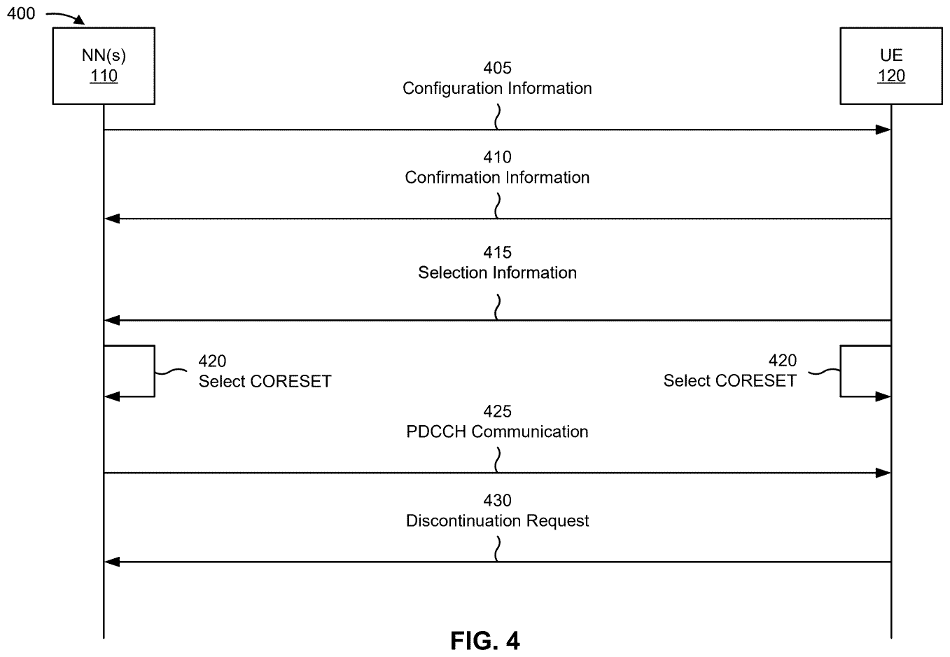

FIG. 4 is a diagram illustrating an example 400 associated with channel aware CORESET allocation. As shown in FIG. 4, a network node 110 and a UE 120 may communicate with one another.

As shown by reference number 405, the network node 110 may transmit, and the UE 120 may receive, configuration information associated with a CORESET configuration process. In some aspects, the CORESET configuration process may be associated with selecting a CORESET from a set of CORESETs.

In some aspects, the configuration information may indicate a set of CORESETs. In some aspects, a quantity of CORESETs included in the set of CORESETs may be defined by a wireless communication standard. Additionally, or alternatively, the quantity of CORESETs included in the set of CORESETs may be configured by a network associated with the network node 110.

In some aspects, each CORESET may be a set of physical resources used to carry control information. In some aspects, the physical resources may correspond to a PDCCH. In some aspects, the configuration information may indicate, for each CORESET included in the set of CORESETs, sets of allocation properties associated with the CORESET.

As an example, the set of CORESETs may include a first CORESET and a second CORESET. The configuration information may indicate sets of first allocation properties associated with the first CORESET and sets of second allocation properties associated with the second CORESET. In some aspects, the sets of allocation properties associated with a CORESET may include an identifier, a frequency domain resource allocation, a time domain resource allocation, a size of the CORESET in the frequency domain, or a size of the CORESET in the time domain, among other examples.

In some aspects, the configuration information may include information indicating a maximal quantity of activated CORESETs. In some aspects, the information indicating the maximal amount of activated CORESETs may be transmitted separately from the configuration information.

In some aspects, the UE 120 may select a CORESET from a subset of CORESETs included in the set of CORESETs. The subset of CORESETs may include a quantity of CORESETs, from the set of CORESETs, that is less than, or equal to, the maximal quantity of activated CORESETs.

In some aspects, the configuration information may indicate a periodicity at which a CORESET is selected from the set of CORESETs. In some aspects, the periodicity may correspond to a periodicity associated with a reference signal (e.g., a periodicity at which a reference signal is transmitted). For example, the periodicity may correspond to a periodicity associated with a CSI-RS.

In some aspects, the configuration information may include information indicating a basis for selecting a CORESET from the set of CORESETs. In some aspects, the information indicating the basis for selecting a CORESET may be transmitted separately from the configuration information.

In some aspects, the basis for selecting a CORESET may be a metric that enables a CORESET to be selected based at least in part on downlink channel conditions that are known to the network node 110 and the UE 120. For example, the basis may enable a CORESET to be selected based at least in part on channel capacities associated with each CORESET, the basis for an RSSI associated with each CORESET, an SNR associated with each CORESET, or mutual information associated with each CORESET, among other examples.

As shown by reference number 410, the UE 120 may transmit, and the network node 110 may receive confirmation information. In some aspects, the confirmation information may indicate an approval of the basis (e.g., the UE 120 agrees to select a CORESET based at least in part on the basis) or a rejection of the basis (e.g., the UE 120 does not agree to select a CORESET based at least in part on the basis).

In some aspects, the confirmation information may comprise an ACK, a NACK, or other information indicating an approval or a rejection of the basis. For example, the confirmation information may comprise an ACK to indicate an approval of the basis and may include a NACK to indicate a rejection of the basis.

In some aspects, the confirmation information may indicate a rejection of the basis. In some aspects, the UE 120 may determine that a calculation of a basis for selecting the CORESET from the set of CORESETs cannot be supported by the UE 120, and the confirmation may indicate the rejection based at least in part on the UE 120 not being able to support the calculation of the basis.

In some aspects, the UE 120 may determine that the calculation of the basis for selecting the CORESET from the set of CORESETs cannot be supported by the UE 120 based at least in part on an operating mode of the UE 120 or a requirement associated with the UE 120, among other examples. For example, the UE 120 may determine that the calculation of the basis for selecting the CORESET from the set of CORESETs based at least in part on the UE 120 operating in a power saving mode or based at least in part on the UE 120 being associated with a latency requirement that is prohibitive to the UE 120 performing a calculation of the basis.

In some aspects, the confirmation information may indicate an approval of the basis. For example, the UE 120 may determine that the calculation of the basis can be supported by the UE 120. The UE 120 may transmit the confirmation indicating the approval of the basis based at least in part on the UE 120 being able to support the calculation of the basis.

As shown by reference number 415, the UE 120 may transmit, and the network node 110 may receive, selection information. In some aspects, the selection information may be transmitted in conjunction with the confirmation information. For example, the selection information and the confirmation information may be transmitted in a same communication.

In some aspects, the selection information may be transmitted separately from the confirmation information. In some aspects, the UE 120 may not transmit the confirmation information and may transmit the selection information to indicate an approval of the basis.

In some aspects, the selection information may be transmitted at a start of a communication and each time information used to calculate the basis changes. In this way, the UE 120 and the network node 110 may prevent the UE 120 and the network node 110 from determining the basis using information associated with uncorrelated receive antennas of the UE 120.

In some aspects, the selection information may include information used to calculate the basis. In some aspects, the information used to calculate the basis May include a result of a measurement or a calculation performed by the UE 120. For example, the UE 120 may measure (or calculate based on a measurement) a variable used to calculate the basis and may transmit selection information indicating the variable to the network node 110.

As an example, a downlink noise's autocovariance matrix may be used to calculate the basis, as described in greater detail below. The UE 120 may determine the downlink noise's autocovariance matrix and may transmit selection information indicating the downlink noise's autocovariance matrix to the network node 110.

In some aspects, the selection information may indicate all of the information needed to calculate the basis. For example, the UE 120 may measure or calculate each variable used to evaluate the basis and may transmit selection information indicating each variable (and any other information that is required to calculate the basis) to the network node 110. In this way, the UE 120 and the network node 110 may calculate the basis and select a CORESET based on the same information.

In some aspects, the information needed to calculate the basis may be determined based at least in part on a signal indicated by the network node 110. For example, the configuration information may indicate a resource (e.g., a slot index) via which a signal is to be periodically transmitted. The UE 120 may measure or calculate a variable based at least in part on the signal transmitted via the indicated resource. In this way, the UE 120 may calculate the information needed to calculate the basis based at least in part on a same signal transmitted via a same resource.

As shown by reference number 420, the network node 110 and the UE 120 may select a CORESET from the set of CORESETs. In some aspects, the network node 110 and the UE 120 may determine to select a CORESET based at least in part on an expiration of a time period.

In some aspects, a CORESET may be periodically selected from the set of CORESETs and the time period may correspond to a periodicity at which a CORESET is to be selected. In some aspects, the periodicity may correspond to a periodicity indicated in the configuration information. For example, the periodicity may correspond to a periodicity associated with a reference signal (e.g., a periodicity at which a reference signal is transmitted).

In some aspects, the network node 110 and the UE 120 may determine to select a CORESET based at least in part on a change in a variable used to calculate the basis. For example, the UE 120 may determine that a current value of a variable used to calculate the basis is different from a value of the variable indicated in the selection information. In some aspects, the UE 120 may determine that a change in the value of the variable satisfies a threshold. The UE 120 may transmit information indicating the current value of the variable to the network node 110. The UE 120 and the network node 110 may determine to select a CORESET from the set of CORESETs based at least in part on the change in the value of the variable.

As an example of calculating the basis, the basis for selecting a CORESET may be associated with the channel capacities associated with each CORESET. In some aspects, the basis for selecting a CORESET may indicate that the UE 120 is to select a CORESET associated with a greatest channel capacity relative to the channel capacities associated with other CORESETs. In some aspects, for each CORESET included in the CORESETs, the UE 120 and the network node 110 may calculate the basis using the following expression:

$${C}_{i} = {Σ}_{( k , n ) ∈ {corset}_{i}} {log}_{2} \vert {I}_{NssxNss} + {H}_{k , n}^{H} {R}_{n n}^{- 1} {H}_{k , n} \vert ,$$

where Cᵢ is the capacity of the i^{th} CORSET; I is the identity matrix; N_{SS} is the number of transmitted streams; Rₙₙ is the downlink noise's autocovariance matrix; and H_{k,n} is the channel at the (k^{th} RE, n^{th} OFDM symbol) which is known at the network node 110 and the UE 120.

In some aspects, for each CORESET, the UE 120 and the network node 110 may evaluate the expression by calculating a sum of the capacities at all the REs that belong to the CORESET. In some aspects, the UE 120 and the network node 110 may select a CORESET from the set of CORESETs associated with a maximal value relative to the values calculated for the other CORESETs included in the set of CORESETs.

As shown by reference number 425, the network node 110 may transmit, and the UE 120 may receive, a PDCCH communication to the UE 120 via one or more resources associated with the selected CORESET. For example, the UE 120 may monitor a set of resources associated with the selected CORESET and may receive the PDCCH communication based at least in part on monitoring the set of resources.

In some aspects, the UE 120 may determine to discontinue the CORESET configuration process. In some aspects, the UE 120 may determine to discontinue the CORESET configuration process based at least in part on a determination that the UE 120 is no longer able to support the calculation of the basis. For example, the UE 120 may determine that the UE 120 is no longer able to support the calculation of the basis based at least in part on a change in an operating mode of the UE 120 (e.g., the UE 120 transitioning to a power saving mode) or a change in a requirement associated with the UE 120 (e.g., a change in a latency requirement associated with the UE 120).

Additionally, or alternatively, the UE 120 may determine to discontinue the CORESET configuration process based at least in part on a set of criteria. In some aspects, the set of criteria may be included in the configuration information. In some aspects, the set of criteria may be received separately from the configuration information. In some aspects, the set of criteria may be pre-configured at the UE 120.

In some aspects, the set of criteria may be satisfied based at least in part on a change in a value of a variable used to calculate the basis satisfying a threshold. The UE 120 may determine to discontinue the CORESET configuration process based at least in part on the change in the value of the variable satisfying the threshold. Additionally, or alternatively, the set of criteria may be satisfied based at least in part on a expiration of a time period, a change in an operating state of the UE 120, or a change in a requirement associated with the UE 120, among other examples.

In these aspects, as shown by reference number 430, the UE 120 may transmit, and the network node 110 may receive, a discontinuation request. In some aspects, the discontinuation request may include information indicating that the UE 120 is no longer able to support the calculation of the basis, the satisfaction of the set of criterial, or a combination thereof.

In some aspects, the network node 110 may transmit information indicating a new basis based at least in part on receiving the discontinuation request and the UE 120 may determine whether to approve or reject the new basis in a manner similar to that described above. In other aspects, the network node 110 may terminate the CORESET configuration process based at least in part on receiving the discontinuation request.

As indicated above, FIG. 4 is provided as an example. Other examples may differ from what is described with respect to FIG. 4.

FIG. 5 is a diagram illustrating an example process 500 performed, for example, at a UE or an apparatus of a UE. Example process 500 is an example where the apparatus or the UE (e.g., UE 120) performs operations associated with channel aware CORESET allocation.

As shown in FIG. 5, in some aspects, process 500 may include receiving configuration information indicating a set of CORESETs, wherein the configuration information indicates sets of allocation properties associated with respective CORESETs included in the set of CORESETs (block 510). For example, the UE (e.g., using reception component 702 or communication manager 706, depicted in FIG. 7) may receive configuration information indicating a set of CORESETs, wherein the configuration information indicates sets of allocation properties associated with respective CORESETs included in the set of CORESETs, as described above.

As further shown in FIG. 5, in some aspects, process 500 may include receiving a PDCCH communication based at least in part on monitoring resources associated with a CORESET included in the set of CORESETs (block 520). For example, the UE (e.g., using reception component 702 or communication manager 706, depicted in FIG. 7) may receive a PDCCH communication based at least in part on monitoring resources associated with a CORESET included in the set of CORESETs, as described above.

Process 500 may include additional aspects, such as any single aspect or any combination of aspects described below or in connection with one or more other processes described elsewhere herein.

In a first aspect, process 500 includes receiving information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.

In a second aspect, alone or in combination with the first aspect, the information indicating the maximal quantity of activated CORESETs is included in the configuration information or is transmitted separately from the configuration information.

In a third aspect, alone or in combination with one or more of the first and second aspects, process 500 includes selecting the CORESET based at least in part on a downlink channel condition, wherein the PDCCH communication is received from a network node, and wherein the downlink channel condition is known at the UE and the network node.

In a fourth aspect, alone or in combination with one or more of the first through third aspects, process 500 includes receiving an indication of a basis for selecting the CORESET from the set of CORESETs.

In a fifth aspect, alone or in combination with one or more of the first through fourth aspects, the basis is associated with channel capacities associated with respective CORESETs included in the set of CORESETs, received signal strength indicators associated with respective CORESETs included in the set of CORESETs, signal-to-noise ratios associated with respective CORESETs included in the set of CORESETs, mutual information associated with respective CORESETs included in the set of CORESETs, or a combination thereof.

In a sixth aspect, alone or in combination with one or more of the first through fifth aspects, process 500 includes transmitting an indication of an approval of the basis for selecting the CORESET.

In a seventh aspect, alone or in combination with one or more of the first through sixth aspects, process 500 includes transmitting an indication of a disapproval of the basis for selecting the CORESET, and receiving information indicating another basis for selecting the CORESET from the set of CORESETS.

In an eighth aspect, alone or in combination with one or more of the first through seventh aspects, process 500 includes transmitting information indicating a value of a parameter used to calculate the basis for selecting the CORESET.

In a ninth aspect, alone or in combination with one or more of the first through eighth aspects, process 500 includes transmitting information indicating an updated value of the parameter, based at least in part on determining a change in the value of the parameter.

In a tenth aspect, alone or in combination with one or more of the first through ninth aspects, process 500 includes receiving information indicating a resource associated with calculating the basis for selecting the CORESET.

In an eleventh aspect, alone or in combination with one or more of the first through tenth aspects, the information indicating the resource associated with calculating the basis for selecting the CORESET includes information indicating a slot index associated with the resource.

In a twelfth aspect, alone or in combination with one or more of the first through eleventh aspects, process 500 includes transmitting a request to discontinue a CORESET configuration process associated with the set of CORESETs.

In a thirteenth aspect, alone or in combination with one or more of the first through twelfth aspects, the request is transmitted based at least in part on a determination that a calculation of a basis for selecting the CORESET from the set of CORESETs cannot be supported based at least in part on an operating mode of the UE, a requirement associated with the UE, or a combination thereof.

In a fourteenth aspect, alone or in combination with one or more of the first through thirteenth aspects, the operating mode of the UE is a power saving operating mode, the requirement associated with the UE is a latency requirement, or a combination thereof.

In a fifteenth aspect, alone or in combination with one or more of the first through fourteenth aspects, process 500 includes receiving information indicating a set of criteria associated with transmitting the request.

In a sixteenth aspect, alone or in combination with one or more of the first through fifteenth aspects, the CORESET is selected from the set of CORESETS based at least in part on an expiration of a time period.

In a seventeenth aspect, alone or in combination with one or more of the first through sixteenth aspects, the CORESET is periodically selected from the set of CORESETS.

In an eighteenth aspect, alone or in combination with one or more of the first through seventeenth aspects, a periodicity at which the CORESET is selected corresponds to a periodicity associated with a channel state information reference signal.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with channel aware CORESET allocation.

As shown in FIG. 6, in some aspects, process 600 may include transmitting configuration information indicating a set of CORESETs, wherein the configuration information indicates sets of allocation properties associated with respective CORESETs included in the set of CORESETs (block 610). For example, the network node (e.g., using transmission component 804 or communication manager 806, depicted in FIG. 8) may transmit configuration information indicating a set of CORESETs, wherein the configuration information indicates sets of allocation properties associated with respective CORESETs included in the set of CORESETs, as described above.

As further shown in FIG. 6, in some aspects, process 600 may include transmitting a PDCCH communication via resources associated with a CORESET included in the set of CORESETs (block 620). For example, the network node (e.g., using transmission component 804 or communication manager 806, depicted in FIG. 8) may transmit a PDCCH communication via resources associated with a CORESET included in the set of CORESETs, as described above.

Process 600 may include additional aspects, such as any single aspect or any combination of aspects described below or in connection with one or more other processes described elsewhere herein.

In a first aspect, process 600 includes transmitting information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.

In a second aspect, alone or in combination with the first aspect, the information indicating the maximal quantity of activated CORESETs is included in the configuration information or is transmitted separately from the configuration information.

In a third aspect, alone or in combination with one or more of the first and second aspects, process 600 includes selecting the CORESET based at least in part on a downlink channel condition.

In a fourth aspect, alone or in combination with one or more of the first through third aspects, process 600 includes transmitting an indication of a basis for selecting the CORESET from the set of CORESETs.

In a fifth aspect, alone or in combination with one or more of the first through fourth aspects, the basis is associated with channel capacities associated with respective CORESETs included in the set of CORESETs, received signal strength indicators associated with respective CORESETs included in the set of CORESETs, signal-to-noise ratios associated with respective CORESETs included in the set of CORESETs, mutual information associated with respective CORESETs included in the set of CORESETs, or a combination thereof.

In a sixth aspect, alone or in combination with one or more of the first through fifth aspects, process 600 includes receiving an indication of an approval of the basis for selecting the CORESET.

In a seventh aspect, alone or in combination with one or more of the first through sixth aspects, process 600 includes receiving an indication of a disapproval of the basis for selecting the CORESET, and transmitting information indicating another basis for selecting the CORESET from the set of CORESETS.

In an eighth aspect, alone or in combination with one or more of the first through seventh aspects, process 600 includes receiving information indicating a value of a parameter used to calculate the basis for selecting the CORESET.

In a ninth aspect, alone or in combination with one or more of the first through eighth aspects, process 600 includes receiving information indicating an updated value of the parameter, based at least in part on determining a change in the value of the parameter.

In a tenth aspect, alone or in combination with one or more of the first through ninth aspects, process 600 includes transmitting information indicating a resource associated with calculating the basis for selecting the CORESET.

In an eleventh aspect, alone or in combination with one or more of the first through tenth aspects, the information indicating the resource associated with calculating the basis for selecting the CORESET includes information indicating a slot index associated with the resource.

In a twelfth aspect, alone or in combination with one or more of the first through eleventh aspects, process 600 includes receiving a request to discontinue a CORESET configuration process associated with the set of CORESETs.

In a thirteenth aspect, alone or in combination with one or more of the first through twelfth aspects, process 600 includes transmitting information indicating a set of criteria associated with transmitting the request.

In a fourteenth aspect, alone or in combination with one or more of the first through thirteenth aspects, the CORESET is selected from the set of CORESETS based at least in part on an expiration of a time period.

In a fifteenth aspect, alone or in combination with one or more of the first through fourteenth aspects, the CORESET is periodically selected from the set of CORESETS.

In a sixteenth aspect, alone or in combination with one or more of the first through fifteenth aspects, a periodicity at which the CORESET is selected corresponds to a periodicity associated with a channel state information reference signal.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive configuration information indicating a set of CORESETs, wherein the configuration information indicates sets of allocation properties associated with respective CORESETs included in the set of CORESETs. The reception component 702 may receive a PDCCH communication based at least in part on monitoring resources associated with a CORESET included in the set of CORESETs.

The reception component 702 may receive information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.

The communication manager 706 may select the CORESET based at least in part on a downlink channel condition, wherein the PDCCH communication is received from a network node, and wherein the downlink channel condition is known at the UE and the network node.

The reception component 702 may receive an indication of a basis for selecting the CORESET from the set of CORESETs.

The transmission component 704 may transmit an indication of an approval of the basis for selecting the CORESET.

The transmission component 704 may transmit an indication of a disapproval of the basis for selecting the CORESET.

The reception component 702 may receive information indicating another basis for selecting the CORESET from the set of CORESETS.

The transmission component 704 may transmit information indicating a value of a parameter used to calculate the basis for selecting the CORESET.

The transmission component 704 may transmit information indicating an updated value of the parameter, based at least in part on determining a change in the value of the parameter.

The reception component 702 may receive information indicating a resource associated with calculating the basis for selecting the CORESET.

The transmission component 704 may transmit a request to discontinue a CORESET configuration process associated with the set of CORESETs.

The reception component 702 may receive information indicating a set of criteria associated with transmitting the request.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit configuration information indicating a set of CORESETs, wherein the configuration information indicates sets of allocation properties associated with respective CORESETs included in the set of CORESETs. The transmission component 804 may transmit a PDCCH communication via resources associated with a CORESET included in the set of CORESETs.

The transmission component 804 may transmit information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.

The communication manager 806 may select the CORESET based at least in part on a downlink channel condition.

The transmission component 804 may transmit an indication of a basis for selecting the CORESET from the set of CORESETs.

The reception component 802 may receive an indication of an approval of the basis for selecting the CORESET.

The reception component 802 may receive an indication of a disapproval of the basis for selecting the CORESET.

The transmission component 804 may transmit information indicating another basis for selecting the CORESET from the set of CORESETS.

The reception component 802 may receive information indicating a value of a parameter used to calculate the basis for selecting the CORESET.

The reception component 802 may receive information indicating an updated value of the parameter, based at least in part on determining a change in the value of the parameter.

The transmission component 804 may transmit information indicating a resource associated with calculating the basis for selecting the CORESET.

The reception component 802 may receive a request to discontinue a CORESET configuration process associated with the set of CORESETs.

The transmission component 804 may transmit information indicating a set of criteria associated with transmitting the request.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a UE, comprising: receiving configuration information indicating a set of CORESETs, the configuration information indicates sets of allocation properties associated with respective CORESETs included in the set of CORESETs; and receiving a PDCCH communication based at least in part on monitoring resources associated with a CORESET included in the set of CORESETs.
Aspect 2: The method of Aspect 1, further comprising: receiving information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.
Aspect 3: The method of Aspect 2, wherein the information indicating the maximal quantity of activated CORESETs is included in the configuration information or is transmitted separately from the configuration information.
Aspect 4: The method of any of Aspects 1-3, further comprising: selecting the CORESET based at least in part on a downlink channel condition, wherein the PDCCH communication is received from a network node, and wherein the downlink channel condition is known at the UE and the network node.
Aspect 5: The method of any of Aspects 1-4, further comprising: receiving an indication of a basis for selecting the CORESET from the set of CORESETs.
Aspect 6: The method of Aspect 5, wherein the basis is associated with channel capacities associated with respective CORESETs included in the set of CORESETs, received signal strength indicators associated with respective CORESETs included in the set of CORESETs, signal-to-noise ratios associated with respective CORESETs included in the set of CORESETs, mutual information associated with respective CORESETs included in the set of CORESETs, or a combination thereof.
Aspect 7: The method of Aspect 5, further comprising: transmitting an indication of an approval of the basis for selecting the CORESET.
Aspect 8: The method of Aspect 7, further comprising: transmitting an indication of a disapproval of the basis for selecting the CORESET; and receiving information indicating another basis for selecting the CORESET from the set of CORESETS.
Aspect 9: The method of Aspect 5, further comprising: transmitting information indicating a value of a parameter used to calculate the basis for selecting the CORESET.
Aspect 10: The method of Aspect 9, further comprising: transmitting information indicating an updated value of the parameter, based at least in part on determining a change in the value of the parameter.
Aspect 11: The method of Aspect 5, further comprising: receiving information indicating a resource associated with calculating the basis for selecting the CORESET.
Aspect 12: The method of Aspect 11, wherein the information indicating the resource associated with calculating the basis for selecting the CORESET includes information indicating a slot index associated with the resource.
Aspect 13: The method of any of Aspects 1-12, further comprising: transmitting a request to discontinue a CORESET configuration process associated with the set of CORESETs.
Aspect 14: The method of Aspect 13, wherein the request is transmitted based at least in part on a determination that a calculation of a basis for selecting the CORESET from the set of CORESETs cannot be supported based at least in part on an operating mode of the UE, a requirement associated with the UE, or a combination thereof.
Aspect 15: The method of Aspect 14, wherein the operating mode of the UE is a power saving operating mode, the requirement associated with the UE is a latency requirement, or a combination thereof.
Aspect 16: The method of Aspect 13, further comprising: receiving information indicating a set of criteria associated with transmitting the request.
Aspect 17: The method of any of Aspects 1-16, wherein the CORESET is selected from the set of CORESETS based at least in part on an expiration of a time period.
Aspect 18: The method of any of Aspects 1-17, wherein the CORESET is periodically selected from the set of CORESETS.
Aspect 19: The method of Aspect 18, wherein a periodicity at which the CORESET is selected corresponds to a periodicity associated with a channel state information reference signal.
Aspect 20: A method of wireless communication performed by a network node, comprising: transmitting configuration information indicating a set of CORESETs, wherein the configuration information indicates sets of allocation properties associated with respective CORESETs included in the set of CORESETs; and transmitting a PDCCH communication via resources associated with a CORESET included in the set of CORESETs.
Aspect 21: The method of Aspect 20, further comprising: transmitting information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.
Aspect 22: The method of Aspect 21, wherein the information indicating the maximal quantity of activated CORESETs is included in the configuration information or is transmitted separately from the configuration information.
Aspect 23: The method of any of Aspects 20-22, further comprising: selecting the CORESET based at least in part on a downlink channel condition.
Aspect 24: The method of any of Aspects 20-23, further comprising: transmitting an indication of a basis for selecting the CORESET from the set of CORESETs.
Aspect 25: The method of Aspect 24, wherein the basis is associated with channel capacities associated with respective CORESETs included in the set of CORESETs, received signal strength indicators associated with respective CORESETs included in the set of CORESETs, signal-to-noise ratios associated with respective CORESETs included in the set of CORESETs, mutual information associated with respective CORESETs included in the set of CORESETs, or a combination thereof.
Aspect 26: The method of Aspect 24, further comprising: receiving an indication of an approval of the basis for selecting the CORESET.
Aspect 27: The method of Aspect 24, further comprising: receiving an indication of a disapproval of the basis for selecting the CORESET; and transmitting information indicating another basis for selecting the CORESET from the set of CORESETS.
Aspect 28: The method of Aspect 24, further comprising: receiving information indicating a value of a parameter used to calculate the basis for selecting the CORESET.
Aspect 29: The method of Aspect 28, further comprising: receiving information indicating an updated value of the parameter, based at least in part on determining a change in the value of the parameter.
Aspect 30: The method of Aspect 24, further comprising: transmitting information indicating a resource associated with calculating the basis for selecting the CORESET.
Aspect 31: The method of Aspect 30, wherein the information indicating the resource associated with calculating the basis for selecting the CORESET includes information indicating a slot index associated with the resource.
Aspect 32: The method of any of Aspects 20-31, further comprising: receiving a request to discontinue a CORESET configuration process associated with the set of CORESETs.
Aspect 33: The method of Aspect 32, further comprising: transmitting information indicating a set of criteria associated with transmitting the request.
Aspect 34: The method of any of Aspects 20-33, wherein the CORESET is selected from the set of CORESETS based at least in part on an expiration of a time period.
Aspect 35: The method of any of Aspects 20-34, wherein the CORESET is periodically selected from the set of CORESETS.
Aspect 36: The method of Aspect 35, wherein a periodicity at which the CORESET is selected corresponds to a periodicity associated with a channel state information reference signal.
Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.
Aspect 38: An apparatus for wireless communication at a device, the apparatus comprising one or more memories and one or more processors coupled to the one or more memories, the one or more processors configured to cause the device to perform the method of one or more of Aspects 1-36.
Aspect 39: An apparatus for wireless communication, the apparatus comprising at least one means for performing the method of one or more of Aspects 1-36.
Aspect 40: A non-transitory computer-readable medium storing code for wireless communication, the code comprising instructions executable by one or more processors to perform the method of one or more of Aspects 1-36.
Aspect 41: A non-transitory computer-readable medium storing a set of instructions for wireless communication, the set of instructions comprising one or more instructions that, when executed by one or more processors of a device, cause the device to perform the method of one or more of Aspects 1-36.
Aspect 42: A device for wireless communication, the device comprising a processing system that includes one or more processors and one or more memories coupled with the one or more processors, the processing system configured to cause the device to perform the method of one or more of Aspects 1-36.
Aspect 43: An apparatus for wireless communication at a device, the apparatus comprising one or more memories and one or more processors coupled to the one or more memories, the one or more processors individually or collectively configured to cause the device to perform the method of one or more of Aspects 1-36.
Aspect 44: A device comprising a processing system that includes one or more processors and one or more code-storing memories coupled with the one or more processors, the processing system configured to cause the device to perform the method of one or more of Aspects 1-36.
Aspect 45: A device comprising a processing system that includes processor circuitry and code-storing memory circuitry, the processing system configured to cause the device to perform the method of one or more of Aspects 1-36.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,” or the equivalent in context, whatever it is that is “associated with ‘a,” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, which are configured, individually or in any combination, to:
receive configuration information indicating a set of control resource sets (CORESETs), wherein the configuration information indicates sets of allocation properties associated with respective CORESETs included in the set of CORESETs; and
receive a physical downlink control channel (PDCCH) communication based at least in part on monitoring resources associated with a CORESET included in the set of CORESETs.

2. The UE of claim 1, wherein the one or more processors are further configured to cause the UE to:
receive information indicating a maximal quantity of activated CORESETs, wherein the CORESET is selected from a subset of CORESETs included in the set of CORESETs, and wherein a quantity of CORESETs included in the subset of CORESETs is less than, or equal to, the maximal quantity.

3. The UE of claim 2, wherein the information indicating the maximal quantity of activated CORESETs is included in the configuration information or is transmitted separately from the configuration information.

4. The UE of claim 1, wherein the one or more processors are further configured to cause the UE to:
select the CORESET based at least in part on a downlink channel condition, wherein the PDCCH communication is received from a network node, and wherein the downlink channel condition is known at the UE and the network node.

5. The UE of claim 1, wherein the one or more processors are further configured to cause the UE to:
receive an indication of a basis for selecting the CORESET from the set of CORESETs.

6. The UE of claim 5, wherein the basis is associated with channel capacities associated with respective CORESETs included in the set of CORESETs, received signal strength indicators associated with respective CORESETs included in the set of CORESETs, signal-to-noise ratios associated with respective CORESETs included in the set of CORESETs, mutual information associated with respective CORESETs included in the set of CORESETs, or a combination thereof.

7. The UE of claim 5, wherein the one or more processors are further configured to cause the UE to:
transmit an indication of an approval of the basis for selecting the CORESET.

8. The UE of claim 7, wherein the one or more processors are further configured to cause the UE to:
transmit an indication of a disapproval of the basis for selecting the CORESET; and
receive information indicating another basis for selecting the CORESET from the set of CORESETS.

9. The UE of claim 5, wherein the one or more processors are further configured to cause the UE to:
transmit information indicating a value of a parameter used to calculate the basis for selecting the CORESET.

10. The UE of claim 9, wherein the one or more processors are further configured to cause the UE to:
transmit information indicating an updated value of the parameter, based at least in part on determining a change in the value of the parameter.

11. The UE of claim 5, wherein the one or more processors are further configured to cause the UE to:
receive information indicating a resource associated with calculating the basis for selecting the CORESET.

12. The UE of claim 11, wherein the information indicating the resource associated with calculating the basis for selecting the CORESET includes information indicating a slot index associated with the resource.

13. The UE of claim 1, wherein the one or more processors are further configured to cause the UE to:
transmit a request to discontinue a CORESET configuration process associated with the set of CORESETs.

14. The UE of claim 13, wherein the request is transmitted based at least in part on a determination that a calculation of a basis for selecting the CORESET from the set of CORESETs cannot be supported based at least in part on an operating mode of the UE, a requirement associated with the UE, or a combination thereof.

15. The UE of claim 14, wherein the operating mode of the UE is a power saving operating mode, the requirement associated with the UE is a latency requirement, or a combination thereof.

16. The UE of claim 13, wherein the one or more processors are further configured to cause the UE to:
receive information indicating a set of criteria associated with transmitting the request.

17. The UE of claim 1, wherein the CORESET is selected from the set of CORESETS based at least in part on an expiration of a time period.

18. The UE of claim 1, wherein the CORESET is periodically selected from the set of CORESETS.

19. A method of wireless communication performed by a user equipment (UE), comprising:
receiving configuration information indicating a set of control resource sets (CORESETs), wherein the configuration information indicates sets of allocation properties associated with respective CORESETs included in the set of CORESETs; and
receiving a physical downlink control channel (PDCCH) communication based at least in part on monitoring resources associated with a CORESET included in the set of CORESETs.

20. A non-transitory computer-readable medium storing a set of instructions for wireless communication, the set of instructions comprising:
one or more instructions that, when executed by one or more processors of a user equipment (UE), cause the UE to:
receive configuration information indicating a set of control resource sets (CORESETs), wherein the configuration information indicates sets of allocation properties associated with respective CORESETs included in the set of CORESETs; and
receive a physical downlink control channel (PDCCH) communication based at least in part on monitoring resources associated with a CORESET included in the set of CORESETs.
